(19) United States
(12) Patent Application Publication
(10) Pub. No.: US 2007/0046631 A1
(43) Pub. Date: Mar. 1, 2007

(54) Computer mouse having keying device

(76) Inventor: Wen Chen Chang, Changhua (TW)

Correspondence Address: CHARLES E. BAXLEY, ESQ., 90 JOHN STREET, THIRD FLOOR, NEW YORK, NY, 10038, US

(21) Appl. No.: 11/501,935

(22) Filed: Aug. 9, 2006

(30) Foreign Application Priority Data
Aug. 23, 2005 (CN) 200520105166.6

(51) Int. Cl. G09G 5/08

(52) U.S. Cl. 345/163

(57) ABSTRACT

A computer mouse includes one or more tracing devices disposed in a housing, and a keying device attached to the housing for entering digital or control signals. A cover is pivotally coupled the housing for supporting the keying device. The keying device includes a number of key pads attached to a casing for being actuated by a user. The keying device includes a NUM LOCK key for changing a function of the key pads to a briefing or meeting function, and the housing includes a light device for generating and emitting a light out of the housing and for indicating that the function of the key pads are acted as the briefing or meeting function.

### BACKGROUND OF THE INVENTION

1. Field of the Invention

The present invention relates to a computer mouse, and more particularly to a computer mouse including a keying entering device for being selectively acted as a keyboard for entering digital signals, and/or for being selectively acted as a broadcasting or controlling device for controlling such as a broadcasting facility or a portable computer or a personal computer to display or to show images or photos or other information in a session or meeting or conference or the like.

2. Description of the Prior Art

Typical computer mouse devices comprise a tracing ball and/or a photo tracing device for location tracing purposes, and three keys for controlling or operating the typical computer mouse devices to enter signals or to control various computer facilities, such as personal computers, portable computers, or the like.

For example, U.S. Pat. No. 5,790,098 to Lin, and U.S. Pat. No. 6,847,846 to Sun disclose two of the typical computer mouse devices each also comprising a typical rotatable tracing ball and three keys for controlling or operating the typical computer mouse devices.

However, the typical computer mouse devices may be moved relative to a supporting pad or surface to provide a relative position or location signal to the computer facilities only, but have no keying entering devices or keyboards for entering digital signals to the computer facilities.

The present invention has arisen to mitigate and/or obviate the afore-described disadvantages of the conventional computer mouse devices.

### SUMMARY OF THE INVENTION

The primary objective of the present invention is to provide a computer mouse including a keying entering device for being selectively acted as a keyboard for entering digital signals, and/or for being selectively acted as a broadcasting or controlling device for controlling such as a broadcasting facility or a portable computer or a personal computer to display or to show images or photos or other information in a session or meeting or conference or the like.

In accordance with one aspect of the invention, there is provided a computer mouse comprising a housing including a chamber formed therein, and including at least one tracing device disposed therein, and a keying device attached to the housing for entering digital or control signals.

The housing includes a cover pivotally coupled thereto, the keying device is attached to the cover. The keying device includes a casing and a number of key pads attached to the casing for being disposed between the casing and the cover and for being actuated by a user.

The cover includes a number of orifices formed therein for receiving the key pads respectively. The casing includes a first serial bus, and a plate disposed in the housing and having a second serial bus for engaging with the first serial bus of the casing. The plate includes a tracing device attached thereto. The housing includes a middle key attached to the tracing device.

The keying device includes a NUM LOCK key for changing a function of the key pads to a briefing function. The housing includes a light device disposed therein for generating and emitting a light out of the housing and for indicating that the function of the key pads are acted as the briefing function.

A circuit board may further be provided and disposed in the chamber of the housing and includes a tracing device attached thereto. The tracing device is a photo tracing device. The circuit board includes a switch button attached thereto for controlling the tracing device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a left and front perspective view of a computer mouse in accordance with the present invention;

FIG. 2 is a right and front perspective view of the computer mouse;

FIG. 3 is an exploded view of the computer mouse;

FIG. 4 is an enlarged partial perspective view of the computer mouse;

FIG. 5 is another enlarged partial perspective view of the computer mouse;

FIG. 6 is a cross sectional view of the computer mouse taken along lines 6-6 of FIG. 2;

FIG. 7 is a perspective view illustrating the operation of the computer mouse;

FIG. 8 is a further enlarged partial perspective view showing the computer mouse as shown in FIG. 7;

FIG. 9 is a further perspective view illustrating the operation of the computer mouse;

FIG. 10 is a top plan schematic view illustrating the operation of the computer mouse, in which a portion of the computer mouse has been removed for showing an inner structure of the computer mouse; and

FIG. 11 is a partial exploded view illustrating the other operation or application of the computer mouse.

### DETAILED DESCRIPTION OF THE PREFERRED EMBODIMENT

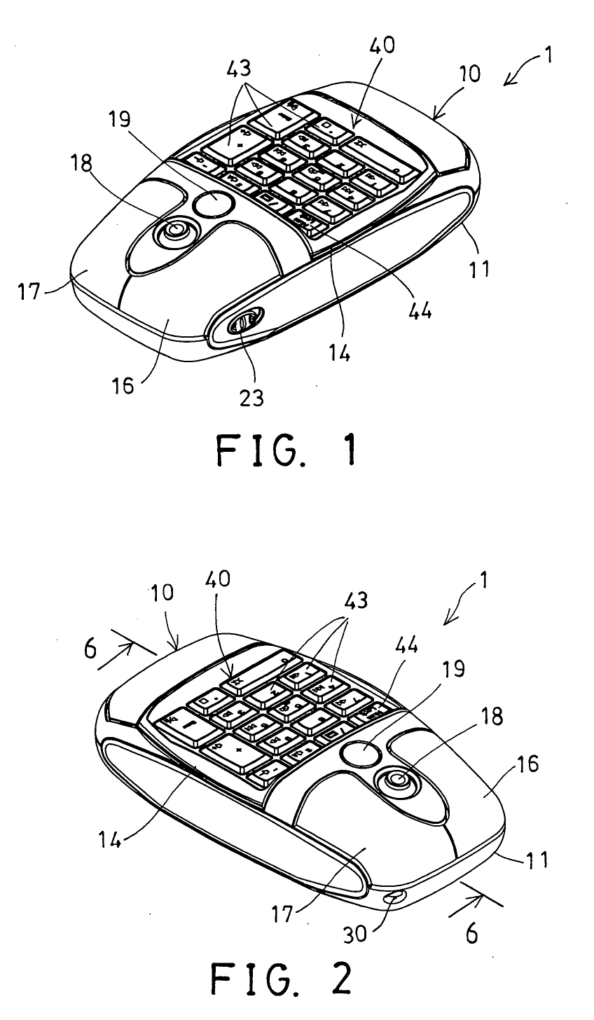

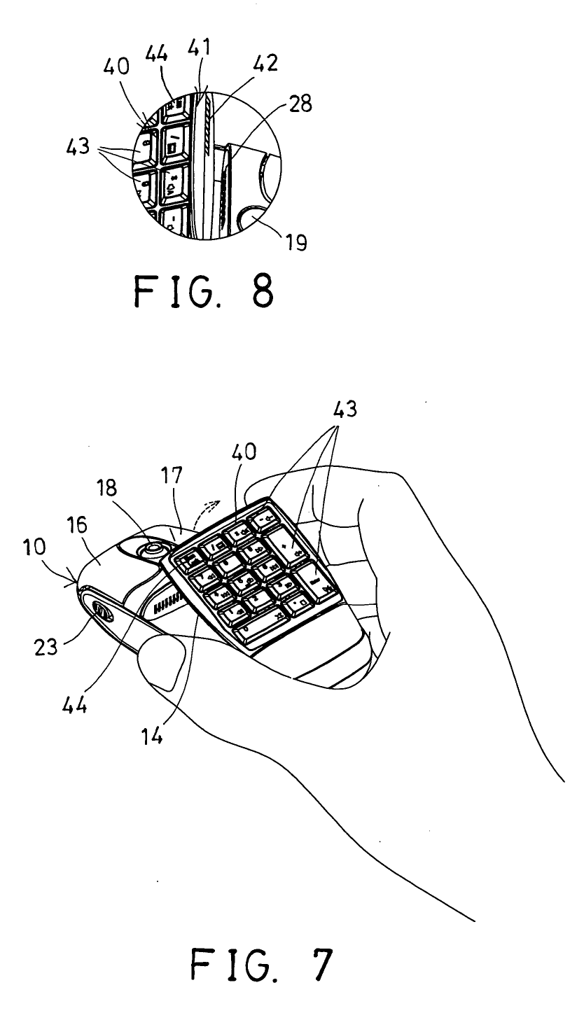

Referring to the drawings, and initially to FIGS. 1-6, a computer mouse 1 in accordance with the present invention comprises a housing 10 including a chassis 11 attached to the bottom portion thereof for forming or defining a chamber 12 in the housing 10, and including a coupling seat 13 disposed in the chamber 12 of the housing 10, and including a cover 14 pivotally or detachably attached or coupled to the coupling seat 13 of the housing 10 with such as a pivot shaft 15 for allowing the cover 14 to be rotated or pivoted relative to the housing 10 (FIG. 7) or to be detachably engaged with the housing 10, and for allowing the cover 14 to suitably or selectively enclose the chamber 12 of the housing 10.

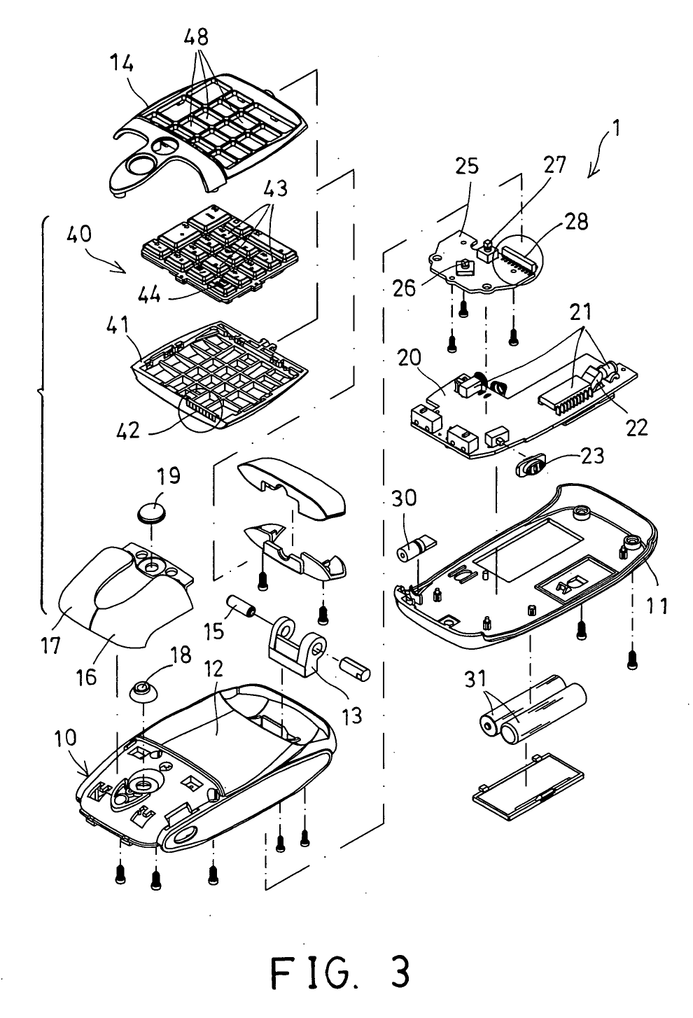

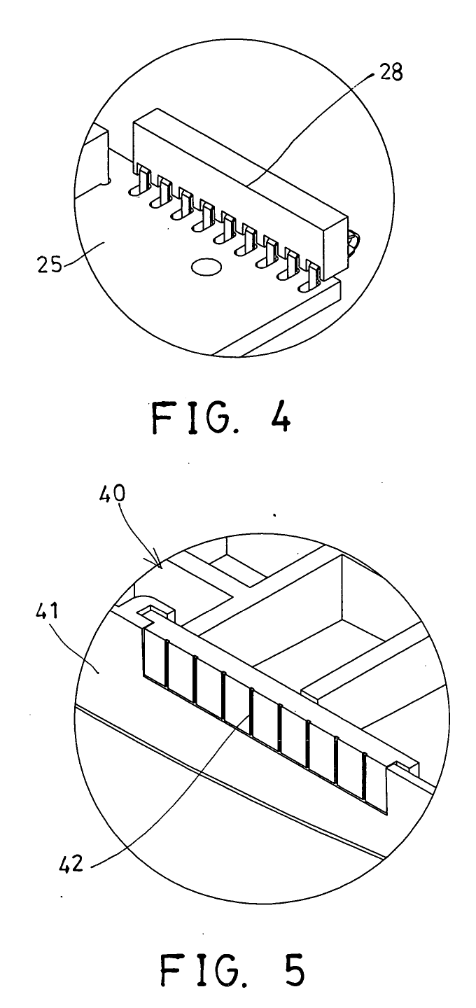

A circuit board 20 is disposed or engaged into the chamber 12 of the housing 10 and secured to the housing 10 with such as fasteners (not shown) or the like, and includes a number or electrical parts or elements 21 disposed thereon, and includes a tracing ball and/or a photo tracing device 22 attached or disposed therein for position or location tracing purposes, and includes a switch button 23 attached to one side portion thereof. A plate 25 is also disposed or engaged into the chamber 12 of the housing 10 and secured to the housing 10 with such as fasteners (not shown) or the like, and includes a switch 26 and another tracing or switching device 27 disposed thereon, and includes a number of terminals or a serial bus 28 disposed thereon (FIGS. 3, 4).

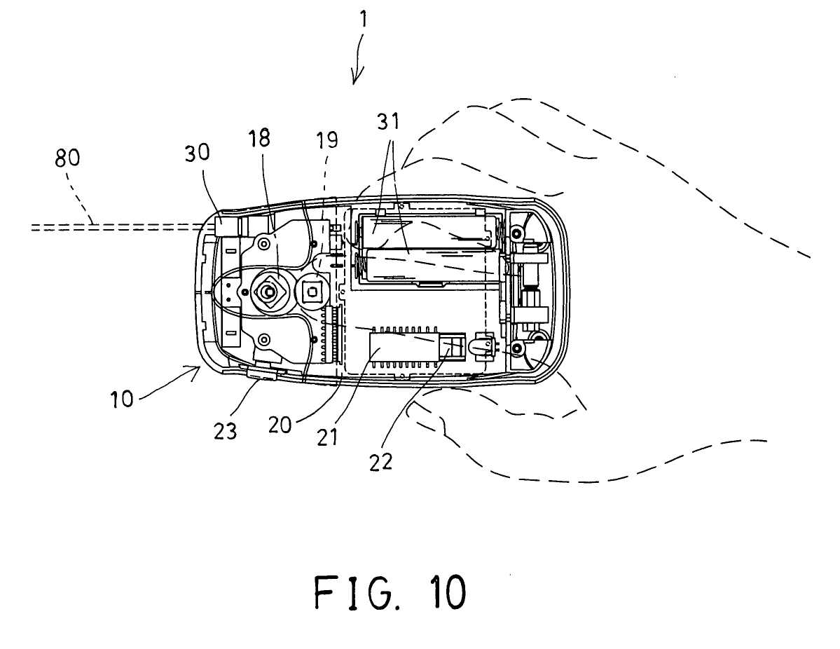

The housing 10 further includes a left key 16, a right key 17, and a middle key 18 attached or disposed on the front portion thereof, in which the middle key 18 is attached or coupled to such as the tracing or switching device 27 of the circuit board 20 for such as tracing or locating purposes, and further includes a switch button 19 also attached or disposed on the front portion thereof and attached or coupled to such as the switch 26 of the circuit board 20. An indicating light device 30 is disposed in the housing 10 for generating and emitting a light out of the housing 10 (FIG. 10), and one or more energizing means or devices 31, such as batteries 31 are disposed in the chamber 12 of the housing 10 and coupled to energize the electrical parts or elements 21 and the light device 30 or the like. The switch button 19 may be used to switch on and off or to control the indicating light device 30, for example.

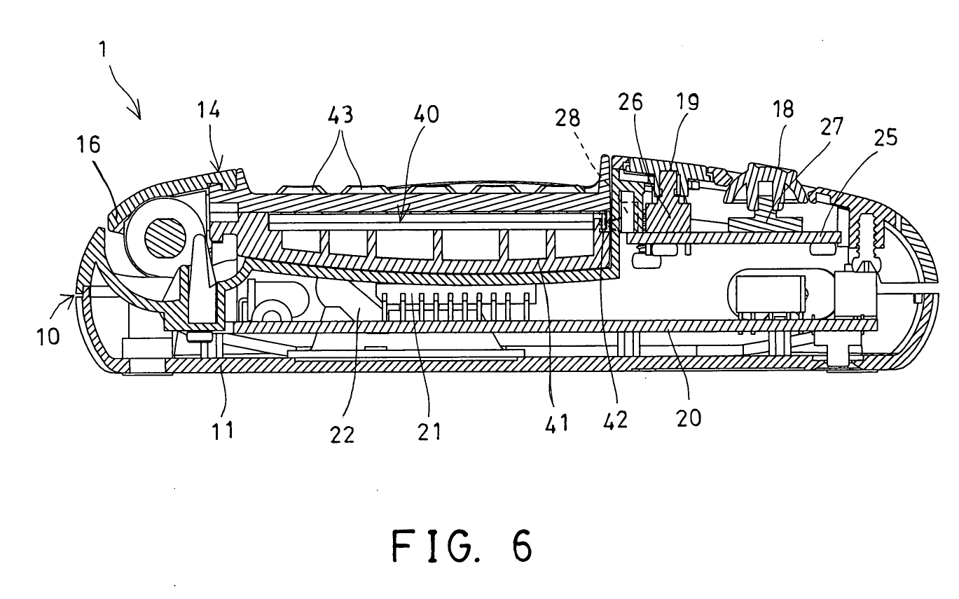

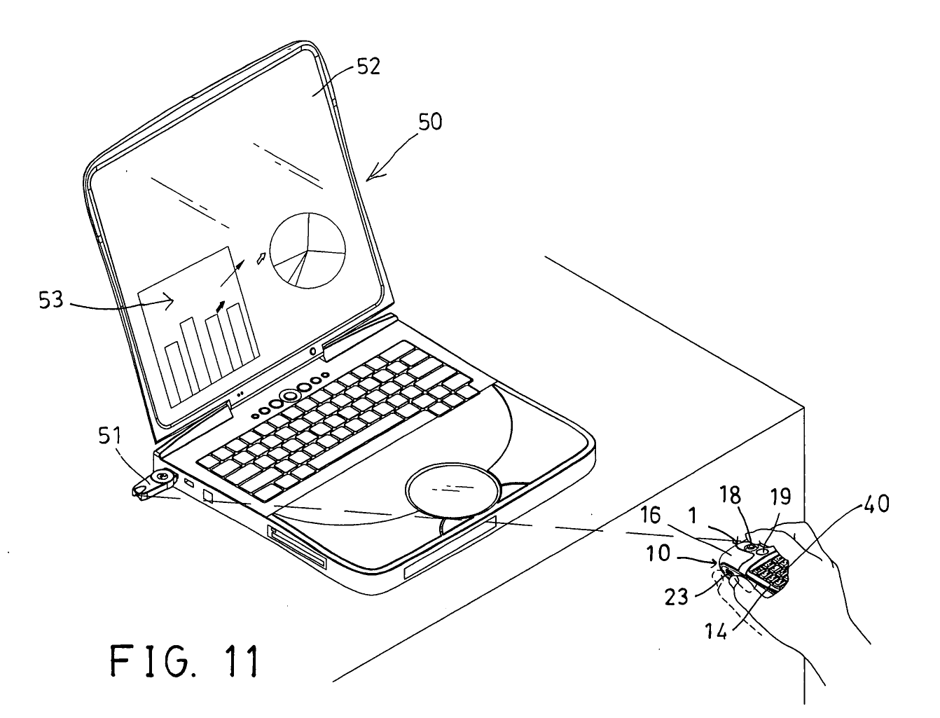

A keying or entering device 40, such as a keyboard 40 includes a casing 41 for engaging with or attaching to the cover 14 or to the housing 10 and having a number of terminals or a serial bus 42 disposed thereon (FIGS. 3, 5) for engaging with the corresponding serial bus 28 of the plate 25 (FIGS. 6, 8) and for electrically coupling the keying device 40 to the plate 25 and/or to the circuit board 20. The keying device 40 or the keyboard 40 includes a number of buttons or key pads 43 attached to the casing 41 and/or disposed between the casing 41 and the cover 14 for being depressed or actuated by the users and for entering digital or control signals to various computer facilities 50, such as the personal computers 50 (FIG. 11), the portable computers (not shown), or the like.

The left key 16 and the right key 17 and the middle key 18 may be used for sending signals or for controlling the computer facilities 50, and either the middle key 18 and the tracing or switching device 27 of the circuit board 20 or the photo tracing device 22 may be selectively used or operated or actuated to control the computer facilities 50. The switch button 23 may be selectively used to control or to switch between the middle key 18 and the tracing or switching device 27 of the circuit board 20 and the photo tracing device 22, or the like.

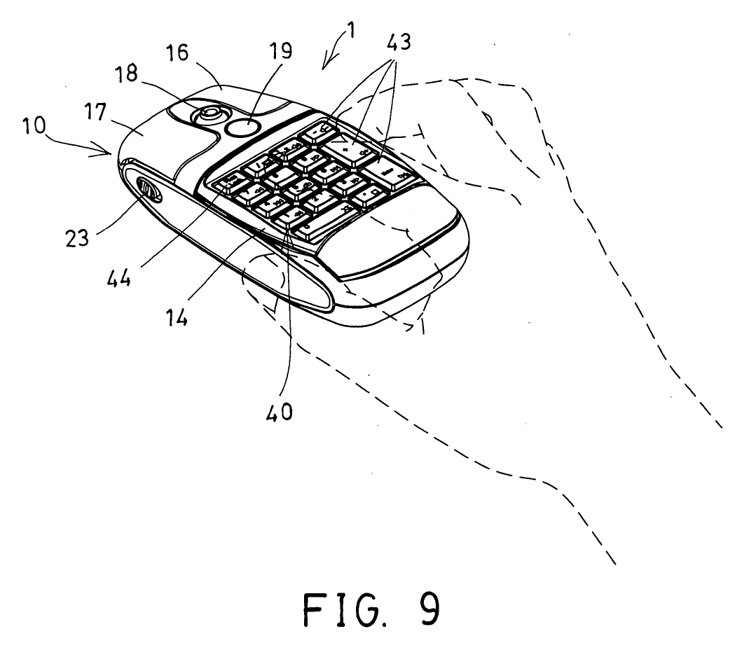

In operation, as shown in FIG. 7, the key pads 43 of the keying device 40 may be disposed or arranged or faced upwardly and engaged through corresponding orifices 48 of the cover 14 (FIG. 3) for allowing the key pads 43 of the keying device 40 to be depressed or actuated by the users (FIG. 9), and thus for allowing the keying device 40 to be selectively operated or acted as a keyboard. The keying device 40 includes one of the keys or key pads 44 as a number lock (NUM LOCK) key 44 for controlling or changing the function of the key pads 43 from the traditional digital keys to the briefing or broadcasting or controlling keys or to a briefing function. The key pads 43 of the keying device 40 may also be disposed or arranged or faced downwardly or inwardly in a storing or receiving position.

For example, when the NUM LOCK key 44 has not been depressed or actuated by the users, the key pads 43 of the keying device 40 may be depressed or actuated by the users and acted as a typical keyboard for entering the typical digital or control signals to the computer facilities 50. When the NUM LOCK key 44 has been depressed or actuated once by the users, the function of the key pads 43 of the keying device 40 may be changed to the briefing or broadcasting or controlling keys (FIG. 11) and the light device 30 may be energized to generating an indicating light 80 (FIG. 10) and to indicate that the function of the key pads 43 of the keying device 40 are worked or acted as the briefing or broadcasting or controlling keys.

For example, as shown in FIG. 11, the broadcasting facility or the computer facility 50 may include a signal receiving device 51 attached or coupled thereto for receiving the signals from the computer mouse 1, and includes a screen 52 for displaying or showing the images or photos or other information 53 that is required for a briefing or session or meeting or conference or the like. At this moment, the key pads 43 of the keying device 40 may be used to control the broadcasting facility or the computer facility 50, such as to control the broadcasting of the computer facility 50, to pause, to change the images or photos or other information 53 in the screen 52, to increase or to decrease the volume of the computer facility 50, or the like.

The computer mouse 1 may be coupled to the signal receiving device 51 or directly to the computer facility 50 with wires or cables or wirelessly. The keying device 40 may be used or acted either as a keyboard for entering the typical digital or control signals to the computer facilities 50 or as a control device to control the broadcasting facility or the computer facility 50.

Accordingly, the computer mouse in accordance with the present invention includes a keying entering device for being selectively acted as a keyboard for entering digital signals, and/or for being selectively acted as a broadcasting or controlling device for controlling such as a broadcasting facility or a portable computer to display or to show images or photos or other information in a session or meeting or conference or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A computer mouse comprising:
a housing including a chamber formed therein, and including at least one tracing device disposed therein, and
a keying device attached to said housing for entering digital or control signals.

2. The computer mouse as claimed in claim 1, wherein said housing includes a cover pivotally coupled thereto, said keying device is attached to said cover.

3. The computer mouse as claimed in claim 2, wherein said keying device includes a casing and a plurality of key pads attached to said casing for being disposed between said casing and said cover and for being actuated by a user.

4. The computer mouse as claimed in claim 3, wherein said cover includes a plurality of orifices formed therein for receiving said key pads respectively.

5. The computer mouse as claimed in claim 3, wherein said casing includes a first serial bus, and a plate disposed in said housing and having a second serial bus for engaging with said first serial bus of said casing.

6. The computer mouse as claimed in claim 5, wherein said plate includes a tracing device attached thereto.

7. The computer mouse as claimed in claim 6, wherein said housing includes a middle key attached to said tracing device.

8. The computer mouse as claimed in claim 3, wherein said keying device includes a NUM LOCK key for changing a function of said key pads to a briefing function.

9. The computer mouse as claimed in claim 8, wherein said housing includes a light device disposed therein for generating and emitting a light out of said housing and for indicating that the function of said key pads is acted as the briefing function.

10. The computer mouse as claimed in claim 1, wherein a circuit board is disposed in said chamber of said housing and includes a tracing device attached thereto.

11. The computer mouse as claimed in claim 10, wherein said tracing device is a photo tracing device.

12. The computer mouse as claimed in claim 10, wherein said circuit board includes a switch button attached thereto for controlling said tracing device.
